(19) United States
(12) Patent Application Publication
(10) Pub. No.: US 2026/0028699 A1
(43) Pub. Date: Jan. 29, 2026

(54) SYSTEM AND METHOD OF FABRICATION OF METAL MATRIX COMPOSITE PARTS

(71) Applicant: Spirit AeroSystems, Inc., Wichita, KS (US)

(72) Inventors: Rahbar Nasserrafi, Wichita, KS (US); Kerrick Dando, Wichita, KS (US); Theodore Eilert, Wichita, KS (US); Saravanan R. Arunachalam, Wichita, KS (US)

(21) Appl. No.: 18/663,252

(22) Filed: May 14, 2024

(51) Int. Cl. C22C 1/10; C22C 29/00

(52) U.S. Cl. CPC C22C 1/10; C22C 29/005

(57) ABSTRACT

Metal matrix composite parts are manufactured by arranging matrix alloy foils and reinforcement fibers to form a bundle of matrix alloy foils and reinforcement fibers, surrounding a periphery of the bundle with metal stripping, and applying electrical current into the bundle and surrounding metal stripping while applying controlled pressure, e.g., in a press. As the bundle of matrix alloy foils and reinforcement fiber is being consolidated, the metal stripping can melt at a lower temperature than the matrix alloy foils and/or react with air to remove at least one of oxygen and nitrogen from the bundle of matrix alloy foils and reinforcement fibers. The metal matrix composite material can be consolidated in an ambient environment outside of a vacuum chamber or furnace.

### FIELD

The present disclosure relates to a system and method for fabricating metal matrix composite parts. More particularly, the present disclosure relates to a system and method of using compression and electrical current to fabricate metal matrix composite parts.

### BACKGROUND

Metal alloy structures and various carbon composite parts are often used in the aircraft industry for structural aircraft parts. However, conventional and advanced materials used for aerospace, propulsion and hypersonic applications have various shortcomings. For example, nickel and cobalt base superalloys exhibit good oxidation resistance, creep resistance, fracture toughness and fatigue resistant. These superalloys also provide good performance over 1000° F, but they are heavy and lose significant strength at temperatures above 1800° F.

Continuous fiber reinforced ceramic matrix composites have good oxidation resistance, corrosion resistance, creep strength, and elevated temperature properties. Additionally, such composites extend the useful temperature of nickel and cobalt base superalloys by over 1500° F, but they are brittle and have low impact strength and low fracture toughness, especially at lower temperatures.

Titanium alloy structures are light weight, highly corrosion resistant at ambient environments, have high strength, have good creep resistance and oxidation resistant up to 1000° F. Advanced titanium alloys exhibit creep and oxidation resistance up to 1200° F with appropriate coatings. However, titanium alloy structures are susceptible to stress corrosion cracking, hydrogen embrittlement, and solid metal induced embrittlement when heated in the presence of certain compounds as low as 600° F.

Carbon-carbon ceramics may perform well at high temperatures. But they are prone to oxidation, and do not have sufficient toughness for certain aerospace applications. Specifically, such ceramics perform well under compression but not where bending is required.

Metal Matrix Composites (MMC) may be used for high temperature applications. However, MMCs—especially those incorporating continuous fibers—are expensive, slow to produce and are typically limited to small parts. Capital-intensive furnaces and vacuum chambers may be required to produce nickel-based MMCs. Such production is energy inefficient, slow, and not economical. Heating and cooling steps may each take several hours.

Thus, the technology described herein addresses current shortcoming of conventional and advanced materials used for aerospace, propulsion, and hypersonic applications.

### SUMMARY OF THE INVENTION

In one aspect, a method of manufacturing metal matrix composite parts comprises arranging matrix alloy foils and reinforcement fibers to form a bundle of matrix alloy foils and reinforcement fibers. A periphery of the bundle of matrix alloy foils and reinforcement fibers is surrounded with metal stripping, Electrical current is applied into the bundle of matrix alloy foils and reinforcement fibers and the surrounding metal stripping to heat the bundle of matrix alloy foils and reinforcement. Simultaneously with applying the electrical current, controlled pressure is applied on the bundle of matrix alloy foils and reinforcement fiber to consolidate the bundle of matrix alloy foils and reinforcement fiber into a metal matrix composite. As the bundle of matrix alloy foils and reinforcement fiber is being consolidated, the metal stripping at least one (i) melts at a lower temperature than the matrix alloy foils and (ii) reacts with air to remove at least one of oxygen and nitrogen from the bundle of matrix alloy foils and reinforcement fibers.

In another aspect, a system for manufacturing metal matrix composite parts comprises a DC power source, a press, a bundle of matrix alloy foils and reinforcement fibers disposed in the press, and electrical leads connecting the DC power to the bundle of matrix alloy foils and reinforcement fiber.

In another aspect, a method of manufacturing metal matrix composite parts comprises arranging matrix alloy foils and reinforcement fibers to form a bundle of matrix alloy foils and reinforcement fibers in an ambient environment outside of a vacuum chamber and a furnace. Electrical current is applied into the bundle of matrix alloy foils and reinforcement fibers in the ambient environment. Controlled pressure is applied on the assembly in the ambient environment.

Other aspects and features will be apparent hereinafter.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a schematic drawing showing a side view of one embodiment of a bundle of matrix alloy foils and reinforcement fibers;

FIG. 1A is a detail view of a portion of FIG. 1;

FIG. 2 is a schematic drawing showing a cutaway top view of the bundle of matrix alloy foils and reinforcement fibers of FIG. 1;

FIG. 3 is a schematic drawing showing a side view of one embodiment of a press that has received one embodiment of a bundle of matrix alloy foils and reinforcement fibers;

FIG. 4 is a schematic drawing showing a close-up view of the press of FIG. 3, compressing the bundle of matrix alloy foils and reinforcement fibers;

FIG. 5 is a schematic drawing of the bundle of matrix alloy foils and reinforcement fibers of FIG. 3 after removal from the press;

FIG. 6 is a schematic drawing of an alternative embodiment of a press that has received one embodiment of a bundle of matrix alloy foils and reinforcement fibers;

FIG. 7 is a schematic drawing of the bundle of matrix alloy foils and reinforcement fibers of FIG. 6 after removal from the press; and

FIG. 8 is a flowchart illustrating a method of making a metal matrix composite part.

### DETAILED DESCRIPTION

To address various disadvantages in regard to heat, strength, and oxidization of traditional materials used in manufacturing structural parts for aircraft, this disclosure provides an improved method for manufacturing metal matrix composite (MMC) structures. Specifically, the disclosed system and method may economically, eﬃciently, and rapidly produce metal matrix composite structures for use between 1600° F and 2200° F. The method allows rapid manufacture of high-performance metal matrix composite components in an ambient environment outside of an autoclave, a vacuum furnace, or other controlled atmosphere chamber. The method uses force pressure applied by a press, together with application of electrical current passing through a bundle of matrix alloy foils (or thin sheets) and reinforcement fiber (or fabric) to heat and diffusion bond matrix alloy foils and reinforcement fiber network into a functional metal matrix component. It can used for making very large structures and produce strong, heat and oxidation resistant metal matrix composites from foil and reinforcement laminates in a short period of time. In some instances, structures may be made in less than 20 minutes.

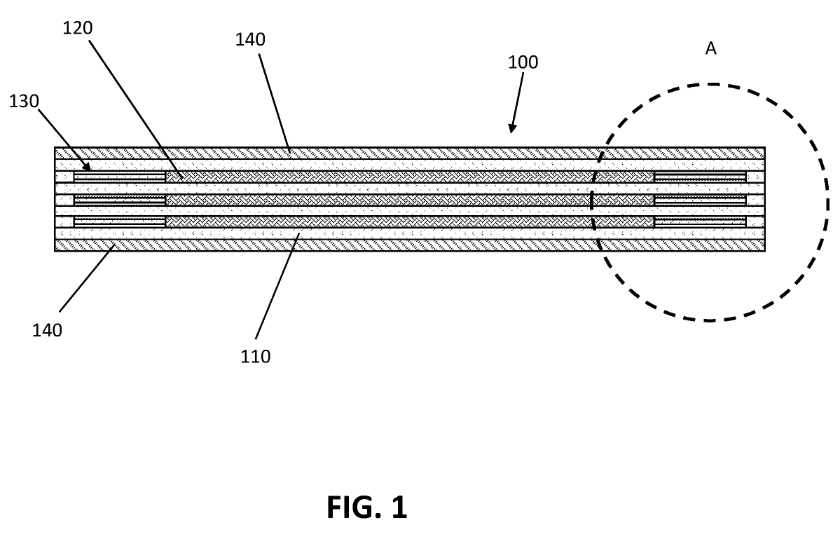

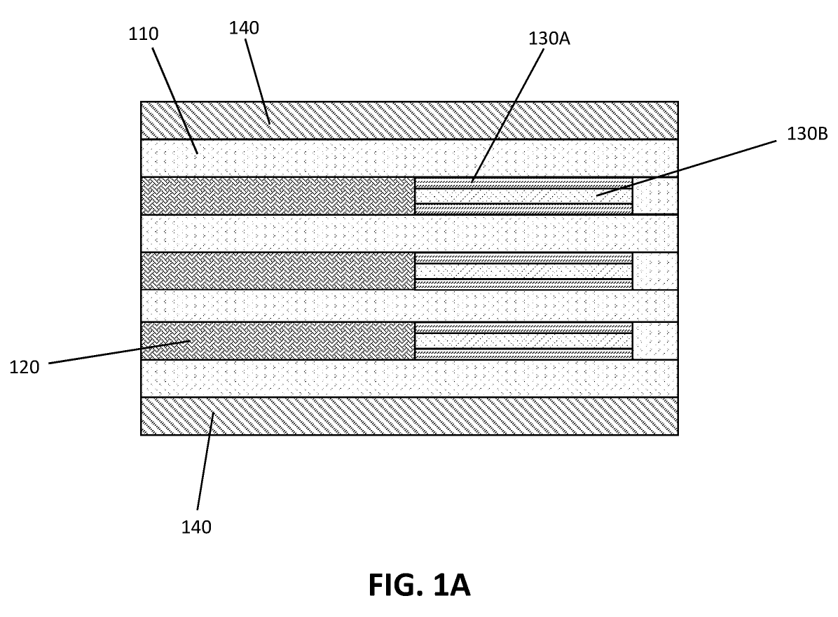

The method includes forming a bundle of matrix alloy foils and reinforcement fibers. FIGS. 1 and 1A show an exemplary embodiment of a bundle 100 of matrix alloy foils 110 and reinforcement fibers 120. In one embodiment, the matrix alloy foils are a nickel base MMC matrix alloy and the reinforcement fibers are carbon fiber or ceramic fibers (e.g., oxide or carbide ceramic fibers). In one embodiment, the matrix alloy foils have a melting point between 2100° F and 2300° F.

Each matrix alloy foil 110 may be made of the same alloy. In alternative embodiments, different alloys may be employed throughout the bundle. Likewise, in the illustrated embodiment, each reinforcement fiber 120 is made of the same material. In alternative embodiments, different materials may be used at different locations in the bundle. Reinforcement fiber can be coated with nickel or copper to assist bonding of the reinforcement fibers to the matrix alloy. Coating can be done by electroplating, electroless plating, or by chemical vapor deposition.

The layers of matrix alloy foils 110 and reinforcement fibers 120 are sequentially arranged to form the bundle 100. While FIG. 1 shows alternating layers of matrix alloy foils and reinforcement fibers, it should be understood that the foils and fibers may be arranged in any desirable formation.

A periphery of the bundle 100 of matrix alloy foils and reinforcement fibers is surrounded with metal strips 130 (broadly, metal stripping). As will be explained in further detail below, the metal strips 130 can include a low melting temperature constituent that melts at a relatively low temperature to seal the periphery of the bundle 100 during consolidation. The metal strips 130 can also include a reactive constituent that acts as a deoxidizer for removing oxygen and nitrogen from the matrix alloy foils 110 and the reinforcement fibers 120 during consolidation. The metal strips 130 may comprise titanium, zirconium, aluminum, copper, hafnium, tantalum, niobium, or a combination thereof. Broadly, metal stripping 130 may be formed from one or more constituent materials that (i) melt at a lower temperature than the matrix alloy foils and/or (ii) react with air to remove at least one of oxygen and nitrogen from the bundle of matrix alloy foils and reinforcement fibers as the bundle of matrix alloy foils and reinforcement fiber is being consolidated.

FIG. 1A is a detail view of a portion of FIG. 1, better showing the metal strips 130. In this embodiment, the metal strips 130 include both a low melting eutectic former 130A and a reactive alloy 130B. Further, the illustrated metal strips 130 are sandwiched between matrix alloy foils 110 and extend around the perimeters of respective reinforcement fibers 120. In exemplary embodiments, the former 130A is made up predominantly of one or more of copper (melts at 1983 F), aluminum (melts at 1220 F), silver (melts at 1762 F), nickel-titanium eutectic (melts at 1730 F), nickel-zirconium eutectic (melts at 1580 F), nickel-manganese eutectic (melts at 1868F) or a combination thereof. One or more of these materials may also be formed as an alloy containing silicon, molybdenum, nickel, boron, phosphorus, and/or chromium. In addition, nickel brazing foils can be used for this purpose. The former 130A may be formed as a mesh or a foil, e.g., a mesh or a foil consisting essentially of one of the above-mentioned materials or a combination of the above-mentioned materials. In an exemplary embodiment, the reactive alloy 130B is made up predominantly of manganese, niobium, tantalum, titanium, zirconium, hafnium, aluminum, or a combination thereof. In one embodiment, the low melting eutectic former 130A has a melting point between 1980° F and 2080° F such as copper or Monel alloys and the reactive alloy 130B has a higher melting point and a higher melting point than the matrix alloy foil 110. Although the reactive alloy 130B (e.g., titanium or zirconium) has higher melting temperatures than nickel, upon contact with the lower melting eutectic formers 130A, they form low melting eutectic phases with a melting point between 1625° F and 1980° F. Although not shown in FIG. 1, reactive alloy strips made for example from the titanium or zirconium can be directly inserted between nickel-based matrix alloys since they form eutectic phases that incipiently melt when in contact with the nickel based matrix alloy.

In the illustrated embodiment, additional layers of the matrix alloy foil 110A surround the metal strips 130, such that none of the metal strips are exposed to the surrounding atmosphere. Using separate low melting eutectic former and reactive alloy as shown in FIG. 1A (e.g., copper or Monel foils) provides a low melting alloy for sealing the plies. In this case, any reactive alloy foil can be used (e.g., Ni-Ta or Ni-Hf with eutectic temperatures above 2400F) for purpose of deoxidation. In alternative embodiments, the additional layers of the matrix alloy foil are omitted. For example, the bundle could comprise a single layer of foil made from alloys such as Ti or Zr that have lower eutectic temperature with Nickel than the consolidation/diffusion bonding temperature. In this case the foil directly seals and deoxidizes the plies.

As further shown in both FIGS. 1 and 1A, the bundle 100 is sandwiched by a superalloy cover foil 140. In one embodiment, the superalloy cover foil 140 is nickel base. In one particular embodiment, the superalloy cover foil 140 is made from high temperature oxidation and/or hot corrosion resistance alloy such as Nickel Alloy 601, Nickel Alloy 602, RA 333, or Haynes 230. These alloys have melting temperatures in the range of 2300 F - 2500 F and can resist oxidation to above 2200 F that can be further increased by application of coatings. In other words, the superalloy cover foil 140 has a melting point that is higher than that of the matrix alloy foil 110.

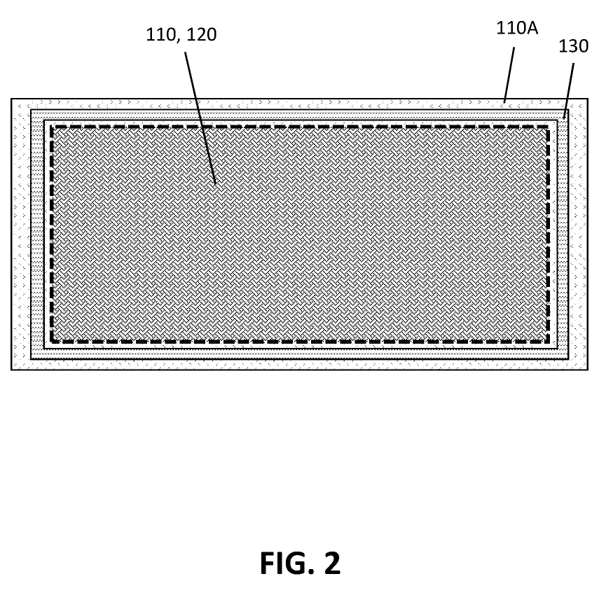

FIG. 2 is a schematic drawing showing a cutaway top view of the bundle of matrix alloy foils and reinforcement fibers of FIG. 1. As can be seen from this view, the alternating layers of matrix alloy foils 110 and reinforcement fibers 120 are surrounded by additional layers of the matrix alloy foil 110A, as well as by the metal strips 130. Although FIG. 2 is not necessarily to scale, the matrix alloy layer 110A is often thicker than the reinforcement fibers fabric, as the matrix alloy preferably completely fills in the empty spaces between the reinforcement fiber 120 to fully envelope/support the reinforcement fibers and also to bond various plies together. But depending on opening space between the fibers, for example when reinforcement fibers constitutes high volume fraction of the MMC, it is still possible that the matrix alloy would not be as thick as the reinforcement fibers fabric.

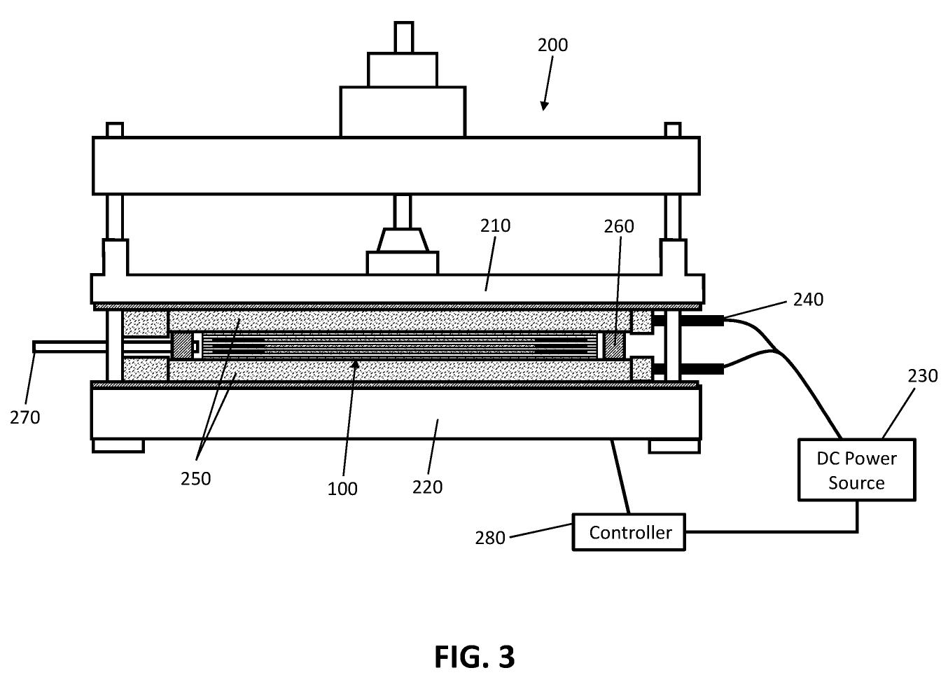

FIG. 3 is a schematic drawing showing a side view of one embodiment of a press 200 that has received one embodiment of a bundle 100 of matrix alloy foils 110 and reinforcement fibers 120. The press 200 is a conventional press that includes a press top 210 and a press bottom 220. It should be understood, however, that the designation of “top” and “bottom” merely reflects the orientation of the illustrated press. The press may be oriented in any direction.

In the illustrated embodiment, the press 200 is open to the atmosphere. In other words, the press 200 is located in an ambient environment outside of a vacuum chamber and outside of a furnace. Likewise, the press does not include a vacuum chamber or a furnace. Because furnaces and vacuum chambers are not required, the press 200—as well as the press top 210 and press bottom 220—may be of any size. In one known embodiment, each of the press top 210 and press bottom 220 is six feet (1.8 m) long, two feet (0.6 m) wide, and 1.5 inches (3.8 cm) thick. In other words, the press top 210 and press bottom 220 may have an area of 12 square feet (1.1 square meters). In another known embodiment, the press top 210 and press bottom 220 may have an area as large as 48 square feet (4.5 square meters) or even larger.

The press 200 is connected to a direct current (DC) power source 230. Electrical power lines 240 connect the DC power source 230 to water-cooled electrical leads 250 that are disposed between the press top 210 and the press bottom 220. The water-cooled electrical leads 250 are directly connected to the matrix alloy foils, reinforcement fibers, and the surrounding metal strips. In an alternative embodiment, the electrical leads are air-cooled instead of water-cooled. In another alternative embodiment, an alternating current (AC) power source may be employed instead of a DC power source. Although the illustrated embodiment incorporates electrical leads 250 into the press top 210 and press bottom 220, other embodiments can separate the leads from the press. For example, it is envisioned that leads may be connected to the bundle 100 on the sides so that current flows horizontally through the bundle. In this case, it is preferable to either use ceramic dies or incorporate a ceramic insulator with high dielectric strength between the bundle 100 and the press 200.

The DC power source 230 may also provide power to operate the press 200. Alternatively, the press 200 may be connected to a separate power source.

In the illustrated embodiment, a high temperature silicone rubber seal 260 is disposed in the press 200, between the press top 210 and the press bottom 220. An argon purge line 270 runs from the interior of the seal 260 to the exterior. In an alternative embodiment, ceramic gasket material is used instead of a high temperature silicone rubber seal. In another alternative embodiment, the seal may be omitted.

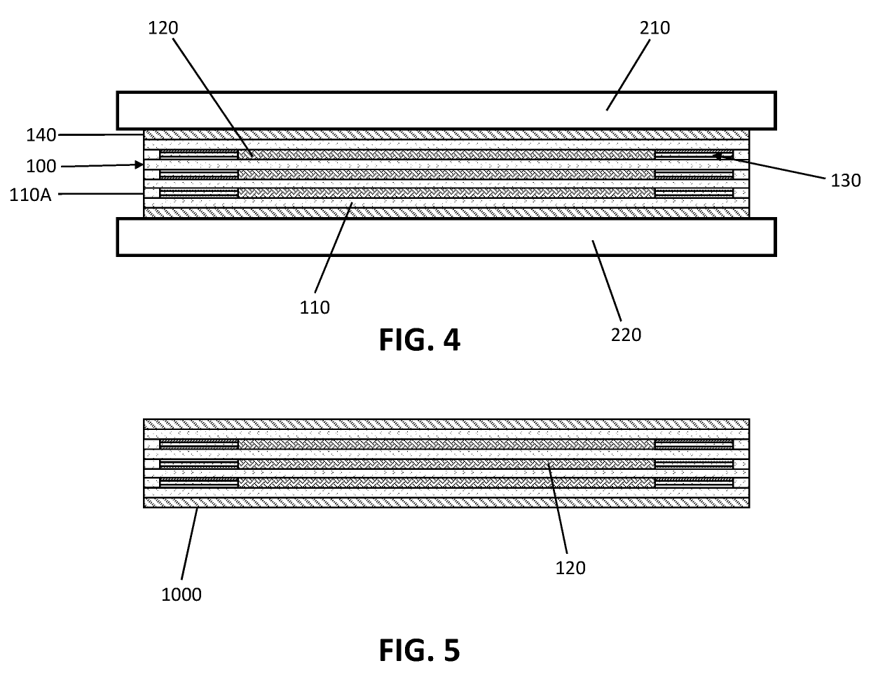

FIG. 4 is a schematic drawing showing a close-up view of the press of FIG. 3 compressing the bundle 100 of matrix alloy foils 110 and reinforcement fibers 120. The bundle 100 is located between the press top 210 and the press bottom 220. As can be seen in this view, the bundle 100 includes the matrix alloy foils 110, reinforcement fibers 120, and the surrounding metal strips 130.

In the illustrated embodiment (FIG. 3), the press 200 and the DC power source 230 are controlled by a controller 280. The controller may be a CPU or a microprocessor. In an alternative embodiment, separate controllers are employed to control the press and the DC power source.

In operation, the controller 280 causes the press 200 to apply a compressive force to the press top 210 and/or the press bottom 220. In the illustrated embodiment, the press bottom 220 is stationary while a downward force is applied to the press top 210. In an alternative embodiment, the press top is stationary while an upward force is applied to the press bottom. In another alternative embodiment, a downward force is applied to the press top while an upward force is applied to the press bottom. In all cases, the controller causes the press to apply a controlled pressure to the bundle 100.

In addition to the application of a compressive force, the controller 280 causes the DC power source 230 to apply an electrical current through the electrical power lines 240 to the water-cooled electrical leads 250. The electrical current then travels through the bundle 100 of matrix alloy foils 110 and the surrounding metal strips 130, thereby heating the bundle 100.

Because the metal strips 130 (FIG. 4) have a lower melting point than the matrix alloy foils 110, the metal strips 130 will melt before the matrix alloy foils 110. Sufficient electrical current is applied to melt the metal strips 130 to form a transient liquid phase that seals the periphery of the bundle of matrix alloy foils 110 and reinforcement fibers 120. The sealing of the periphery of the bundle of matrix alloy foils 110 and reinforcement fibers 120 creates an in-situ sealed chamber.

In one embodiment, the press 200 continues to apply controlled pressure and the DC power source 230 continues to apply electrical current after the in-situ sealed chamber is created. The electrical current and pressure continues to generate heat, reaching the melting point of the matrix alloy foils 110. The matrix alloy foils 110 thus melt and the applied pressure forces the molten metal into the space between the reinforcement fibers 120. The use of compression force ensures contact among the individual matrix alloy foils 110 and the reinforcement fibers 120 before and during the diffusion bonding process.

During this process, the Electroless nickel coated fibers create a self-fluxing surface (0.0002–0.002 inches), which improves wetting and helps to completely infiltrate and encapsulate the electroless coated reinforcement fibers network under simultaneous application of pressure, temperature, and time.

The physical effect of passing electrical current through an electrical conductor to produce thermal energy is known as joule heating. The joule heating process may be described as a “green” process because it uses limited resources—only direct heat is applied through electricity. The joule heating process described herein increases localized resistance between the reinforcement fibers 120 the matrix alloys 110, thereby allowing melting at the fiber/foil interface and allowing full penetration and encapsulation of the fibers. However, in an alternative embodiment, induction heating may be used. For example, induction heating may be employed provided ceramic tooling with embedded induction coils is provided and a ceramic gasket is used in lieu of high temperature silicone.

There is no need for a separate vacuum chamber with the illustrated embodiment. Instead, tooling can be evacuated and optionally back purged with inert gas directly to remove moisture and volatile elements. The reactive alloys 130B of the metal strips 130 act as a de-oxidizer for removing any remnant oxygen and nitrogen and diffusion barriers to allow full bonding.

Likewise, there is also no need for a furnace with this system. The electrical current directly heats the bundle 100 through the Joule heating process, without a need for an external furnace. The process may be characterized as extremely rapid; approximately a kilowatt hour of energy can melt approximately 1 to 3 pounds of nickel or titanium base alloys. Thus, large bundles of matrix alloy foils and reinforcement fibers can be consolidated and formed in minutes. In one embodiment, the resulting metal matrix composite may be used in applications at temperatures between 1600° F and 2200° F.

FIG. 5 is a schematic drawing of the finished metal matrix composite structure 1000, still embedded with reinforcement fibers 120, after removal from the press. In this embodiment, because the press top 210 and press bottom 220 are planar components, the resulting metal matrix composite structure 1000 is likewise a planar structure.

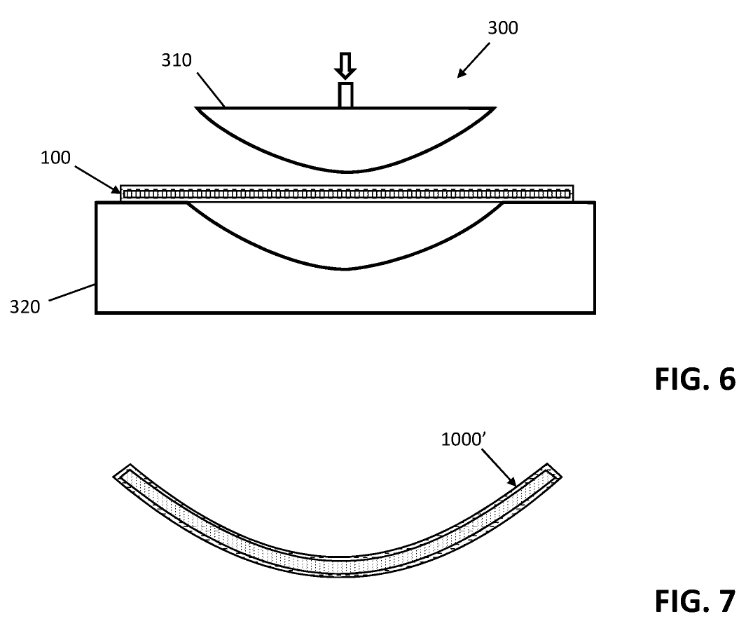

In an alternative embodiment, a shaped die may be used instead of a planar press. For example, FIG. 6 is a schematic drawing of an alternative embodiment of a press 300 that has a curved press top 310 and a corresponding recessed press bottom 320. In the illustrated embodiment, the press 300 receives a bundle 100 of matrix alloy foils and reinforcement fibers. Controlled pressure and an electrical current is applied in the same manner described above with reference to FIGS. 3 and 4. Because of the shape of the press top 310 and press bottom 320, the resulting metal matrix composite structure 1000' is curved by the application of the controlled pressure and the electrical current, as shown in FIG. 7.

FIG. 6 illustrates pressing a flat bundle of matrix alloy foils and reinforcement fibers for consolidation and forming into desired shape. However, this disclosure also allows for laying of bundle of matrix alloy foils and reinforcement fibers into a shaped die in which the press functions only for consolidation of the bundle. In this option, the bundle would have the rough contour of the die cavity prior to placement in the die. The tooling functions to consolidate the pre-shaped bundle.

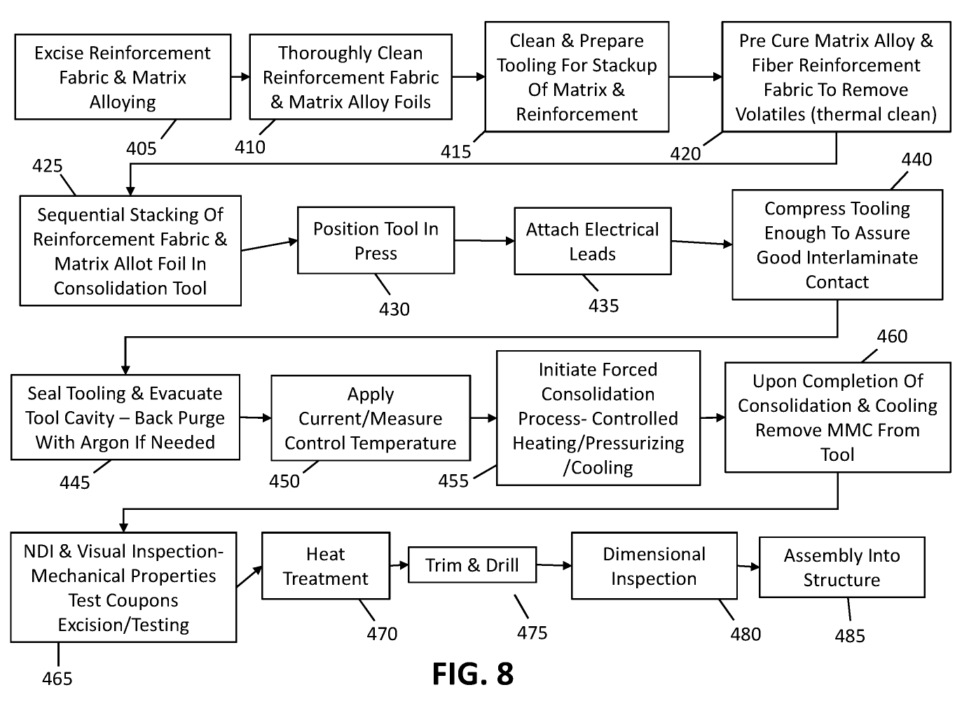

While the method of making a metal matrix composite part has been described above with reference to FIGS. 1–7, FIG. 8 is a flowchart illustrating a more detailed method 400 of making a metal matrix composite part. An operator first excises reinforcement fabric and matrix alloying (405) and cleans the reinforcement fabric and matrix alloy foils (410). The operator also cleans and prepares tooling for the stacking of the reinforcement fabric and matrix alloy foils (415). Pre-cleaning and surface activation of the surfaces of the matrix alloy foils and the reinforcement fiberss can result in excellent metallurgical bonds between adjacent alloy foils and reinforcement fibers.

The operator may also optionally perform thermal cleaning the reinforcement fabric and matrix alloy foils (420). The step of thermal cleaning may remove volatile components from the matrix alloy foils or from the reinforcement fabric.

The operator then sequentially stacks the reinforcement fabric and matrix alloy foils in a consolidation tool (425) and may place metal strips around the periphery of the reinforcement fabric and matrix alloy foils. The operator may also place superalloy cover foils on the top and bottom of the stack of reinforcement fabric and matrix alloy foils. The operator then positions the tool in a press (430). The operator attaches electrical leads to the bundle of reinforcement fabric and matrix alloy foils (435). The operator may then optionally compress the tooling enough to assure sufficient interlaminate contact (440).

The operator then seals the tooling and evacuates the tool cavity (445). The operator may also optionally back purge the cavity with argon, if necessary. The controller then applies current and measures the temperature (450) while it also initiates the forced consolidation process through controlled heating, pressurizing, and cooling (455). The controller then stops the flow of electrical current and opens the press. After the resulting piece is cooled, the operator removes it from the press (460).

The operator may then inspect the resulting piece and test its mechanical properties (465). If necessary, additional heat treatment (470) and shaping (such as trimming and drilling) may be performed (475). The operator may then perform a final dimensional inspection (480) and place the resulting piece in a structure (485).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant’s general inventive concept.

What is claimed is:

1. A method of manufacturing metal matrix composite parts, the method comprising:
arranging matrix alloy foils and reinforcement fibers to form a bundle of matrix alloy foils and reinforcement fibers;
surrounding a periphery of the bundle of matrix alloy foils and reinforcement fibers with metal stripping;
applying electrical current into the bundle of matrix alloy foils and reinforcement fibers and the surrounding metal stripping to heat the bundle of matrix alloy foils and reinforcement; and
simultaneously with applying the electrical current, applying controlled pressure on the bundle of matrix alloy foils and reinforcement fiber to consolidate the bundle of matrix alloy foils and reinforcement fiber into a metal matrix composite,
wherein as the bundle of matrix alloy foils and reinforcement fiber is being consolidated, the metal stripping at least one (i) melts at a lower temperature than the matrix alloy foils and (ii) reacts with air to remove at least one of oxygen and nitrogen from the bundle of matrix alloy foils and reinforcement fibers.

2. The method of claim 1, wherein the method is performed outside of a vacuum chamber.

3. The method of claim 1, wherein the method is performed outside of a furnace.

4. The method of claim 1, wherein the applying of controlled pressure is performed by a press.

5. The method of claim 1, wherein the applying of electrical current is performed with a DC power source.

6. The method of claim 1, wherein the applying of electrical current includes applying sufficient electrical current to melt the matrix alloy foils.

7. The method of claim 1, wherein the applying of electrical current includes applying sufficient electrical current to melt the metal stripping to form the transient liquid phase that seals the periphery of the bundle of matrix alloy foils and reinforcement fibers.

8. The method of claim 7, wherein the sealing of the periphery of the bundle of matrix alloy foils and reinforcement fibers creates an in-situ sealed chamber.

9. The method of claim 1, further comprising cleaning external surfaces of the bundle of matrix alloy foils and reinforcement fibers before the applying of electrical current and before the applying of controlled pressure.

10. The method of claim 1, further comprising coating the reinforcement fibers with electroless nickel or copper plating.

11. The method of claim 1, wherein the matrix alloy foils are nickel base alloy.

12. The method of claim 1, wherein the metal stripping comprises a low melting eutectic former and a reactive alloy in contact with the low melting eutectic former.

13. The method of claim 12, wherein the low melting eutectic former is predominantly copper, aluminum, silver, nickel-titanium eutectic, nickel-zirconium eutectic, nickel-manganese eutectic, or a combination thereof

14. The method of claim 12, wherein the reactive alloy is predominantly manganese, niobium, tantalum, titanium, zirconium, hafnium, aluminum, or a combination thereof.

15. A system for manufacturing metal matrix composite parts, the system comprising:
a DC power source;
a press;
a bundle of matrix alloy foils and reinforcement fibers disposed in the press;
electrical leads connecting the DC power to the bundle of matrix alloy foils and reinforcement fiber.

16. The system of claim 15, wherein the electrical leads are water cooled.

17. The system of claim 15, wherein the press includes curved plates.

18. A method of manufacturing metal matrix composite parts, the method comprising:
arranging matrix alloy foils and reinforcement fibers to form a bundle of matrix alloy foils and reinforcement fibers in an ambient environment outside of a vacuum chamber and a furnace;
applying electrical current into the bundle of matrix alloy foils and reinforcement fibers in the ambient environment; and
applying controlled pressure on the assembly in the ambient environment.

19. The method of claim 16, wherein the alloy foils are nickel base alloy.

20. The method of claim 16, wherein the reinforcement fibers are carbon fibers or ceramic fibers.
